(19) United States
(12) Patent Application Publication
(10) Pub. No.: US 2007/0090706 A1
(43) Pub. Date: Apr. 26, 2007

(54) Frictionless suspension structure

(76) Inventors: Glenn R. Davis, Tucson, AZ (US); Patrick G. Davis, Tucson, AZ (US)

Correspondence Address: Lawrence R. Oremland, Suite C-214, 5055 E. Broadway Blvd., Tucson, AZ, 85711, US

(21) Appl. No.: 11/583,618

(22) Filed: Oct. 19, 2006

Related U.S. Application Data
(60) Provisional application No. 60/596,781, filed on Oct. 20, 2005.

(51) Int. Cl. H02K 7/09

(52) U.S. Cl. 310/90.5

(57) ABSTRACT

A new and useful frictionless suspension structure is provided, that can be used with structures such as axles, hinges and other similar types of structures (especially structures where one member rotates relative the other member) can produce various attractive features such as significant energy savings, preserving component life, etc. A frictionless suspension structure comprises a first member with at least one magnet connected thereto and a second member with at least one magnet connected thereto. The magnets connected with the first and second members are configured and oriented with respect to each other to (i) establish respective magnetic fields that interact to suspend one of the members from the other member in a predetermined self centered orientation without physical contact between the members, and (ii) maintain the one of the members suspended from the other member in the predetermined self centered orientation without physical contact between the members.

### RELATED APPLICATION/CLAIM OF PRIORITY

This application is related to and claims priority from provisional application Ser. No. 60/596,781 filed Oct. 20, 2005, which provisional application is incorporated by reference herein.

### BACKGROUND AND SUMMARY

This application results from applicants' recognition that removing friction from structures such as axles, hinges and other similar types of structures (especially structures where one member rotates relative the other member) can produce various attractive features such as significant energy savings, preserving component life, etc.

In accordance with the principles of the present invention, a frictionless suspension structure comprises a first member with at least one magnet connected thereto and a second member with at least one magnet connected thereto. The magnets connected with the first and second members are configured and oriented with respect to each other to (i) establish respective magnetic fields that interact to suspend one of the members from the other member in a predetermined self centered orientation without physical contact between the members, and (ii) maintain the one of the members suspended from the other member in the predetermined self centered orientation without physical contact between the members.

In a preferred embodiment, the first and second members have respective pairs of magnets that interact to suspend and maintain the one member suspended from the other member in the predetermined self centered orientation without physical contact between the members. Additionally, each respective pair of magnets comprises an inner magnet and an outer magnet, and the interaction between the magnetic fields of the inner and outer magnets is configured to enable the members to rotate relative to each other without physical contact between the members while the one member is maintained suspended from the other member in the predetermined self centered orientation. Also, the magnets of each respective pair of magnets each has a cup shaped configuration and each inner cup shaped magnet on one member is configured to be located inside and spaced from a respective outer cup shaped magnet on the other member. Each cup shaped outer magnet has a pole on its concave inside and each cup shaped inner magnet has a similar pole on its convex outside.

A particularly useful feature of the present invention is that with the frictionless suspension structure the cup shaped magnets and their respective magnetic fields are configured to create and maintain a predetermined self centering self supporting structure for the fist and second members.

Also, with a frictionless coupling according to the principles of the present invention, a driver device can be connected with one of the members. Alternatively, or in addition to the driver device, a device can be provided that produces energy from relative rotation between the members.

A particularly useful structure that can be produced with the principles of the present invention is a hinge structure, in which the fist and second members are oriented vertically, in the predetermined self centered orientation, one of the members is connected to a frame and the other member is connected to a component that is supported for rotation relative to the frame by the hinge structure. In such a hinge structure, the magnetic fields of the cup shaped magnets are also oriented to maintain a vertical spacing between the magnets.

The frictionless suspension structure of the present invention is particularly useful as a hinge structure. The first and second members would comprise first and second hinge plates that are relatively rotatable about a shaft. The inner magnets of each pair of magnets would be connected to one hinge plate and the outer magnets of each pair of magnets would be connected to the other hinge plate, in a manner that suspends one hinge plate from the other hinge plate in a predetermined self centered orientation and allows relative pivotal movement of the hinge plates relative to each other about the shaft, without physical contact between the hinge plates. The pairs of magnets would be spaced along the shaft and allow relative pivotal movements of the hinge plates about the shaft. In coupling the hinge plates with the pairs of magnets, one of the hinge plates has a pair of concave portions that are received by and pressed against the concave inner surfaces of the inner magnets of each of the magnet pairs, and the other hinge plate has concave portions that receive and are pressed against the convex outer surfaces of the outer magnets of the of the magnet pairs. If the magnet pairs have concave portions that face in the same direction, additional structure is provided to maintain the frictionless suspension, in the form of a spacer magnet that is connected with the one hinge plate that is pressed against the inner magnets, and is spaced from the outer convex surface of one of the pairs of magnets connected to the other hinge plate. The spacer magnet and the outer convex surface of the magnet are connected to the other hinge plate have magnetic fields that maintains the spacer plate in spaced from the outer convex surface of the one of the pairs of magnets connected to the other hinge plate, without physical contact between the outer convex surface and the spacer magnet.

In this application, reference to a magnet being “cup shaped” means that the magnet has a substantially continuous wall that defines an opening that encompasses (or envelops) a volume of the surrounding air. In addition, reference to a “frictionless” suspension structure means that the suspension structure is free of contact friction that would be produced by two parts that are in contact with each other when they move relative to each other.

Further features of the present invention will become apparent from the following detailed description and the accompanying drawings.

### BRIEF DESCRIPTION OF THE DRAWINGS

FIG. 1 is a side view of a frictionless suspension structure, according to the principles of the present invention;

FIG. 2 is a sectional view of a portion of the frictionless suspension structure of FIG. 1;

FIG. 3 is a side view of a modified frictionless support structure, according to the principles of the present invention;

FIG. 4 is a sectional view of an embodiment of a hinge structure formed with a frictionless suspension structure, according to the principles of the present invention; and

FIG. 5 is a schematic three dimensional illustration of a frictionless suspension structure, according to the principles of the present invention.

### DETAILED DESCRIPTION

As described above, the present invention relates to a frictionless suspension system that can be used in various types of applications. The principles of the invention are described below in connection with a general type of frictionless suspension system, and also in connection with a hinge structure. However, from the description, the manner in which the principles of the present invention can be used in various other types of devices will be apparent to those in the art.

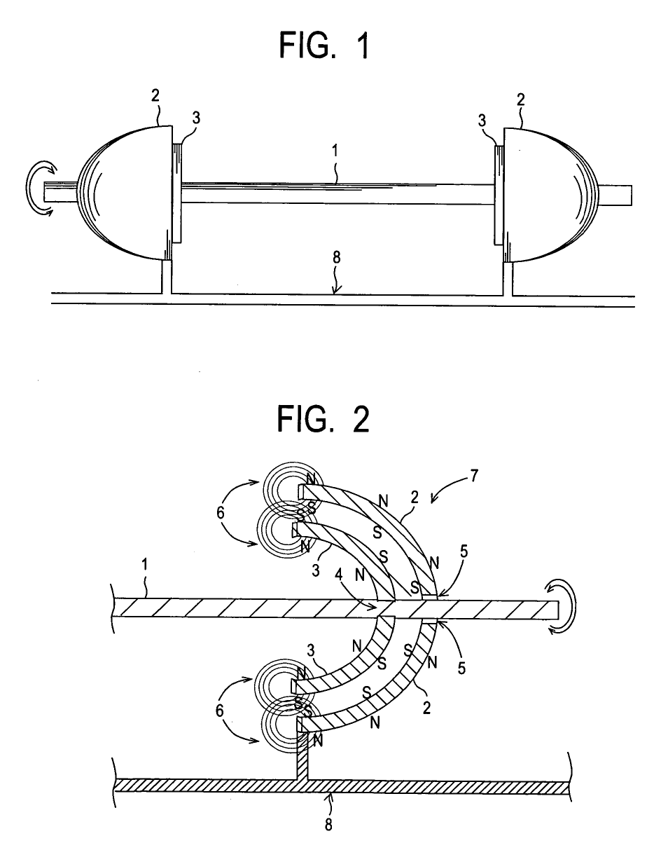

The general principles of a frictionless suspension system, according to the principles of the present invention, can be appreciated from FIGS. 1 and 2. A first member and a second member are provided, e.g. in the form of a shaft 1 (first member) and a support 8 (second member) from which the shaft 1 is suspended by the frictionless suspension structure of the present invention. In the example of FIGS. 1 and 2, the shaft 1 is suspended from the support 8 in a manner that enables the shaft 1 to rotate in either direction while suspended from the support 8.

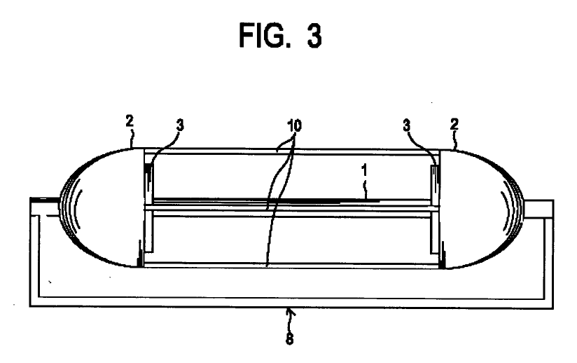

FIG. 3 shows an alternative to the structure of FIGS. 1 and 2. In FIG. 3, a shaft 1 is fixed to a support 8, and one or more coupling members 10 extend between respective outer magnets 2 so that the coupling members 10 and the magnets 2 form an integral member that is suspended from the shaft 1 by a frictionless suspension structure according to the principles of the present invention. That frictionless support structure enables the integral member to rotate about the shaft 1 while suspended from the shaft 1. While FIG. 3 shows several coupling members 10, those members can also be replaced by a single sleeve shaped member that extends between magnets 2, and forms the integral member.

FIG. 2 shows further details of the frictionless suspension structure of FIG. 1. A magnet pair 7 is formed by an inner magnet 3 and an outer magnet 2. Each of the inner and outer magnets 3 and 2 comprises a ring that is cup shaped such that each magnet has a concave inside and a convex outside. The inner cup shaped magnet 3 is located inside the outer cup shaped magnet 2, and is spaced from the outer cup shaped magnet 2. The outer magnet 2 is connected to the support structure 8 by any suitable means (e.g. the outer magnet 2 can be adhesively bonded or mechanically coupled to the support structure 8). The inner magnet 3 is fixed to the shaft 1 by any suitable means (e.g. the shaft 1 can fit through an opening in the inner magnet and can be adhesively or mechanically coupled to the wall of the opening in the inner magnet 3). The outer magnet 2 has an opening 5 through which the shaft 1 can extend, and the opening 5 is large enough that the shaft 1 can rotate inside the opening without physically contacting the wall of the opening 5.

The magnets 2, 3 are configured and oriented with respect to each other to establish respective magnetic fields (portions of which are shown at 6 in FIG. 2) that interact to suspend the shaft 1 from the support structure 8 without physical contact between the shaft 1 and the support structure 8. Specifically, the pole on the concave inside of the magnet 2 is a south (S) pole and the pole on the convex outside of the magnet 3 is also a south (S) pole. Thus, those poles establish magnetic fields that repel each other, and thereby maintain the magnets 2, 3 oriented in the relationship shown in the Figures, but physically separated from each other. In addition, because the magnets 2 and 3 are cup shaped, and magnet 2 is located inside and spaced from magnet 3, and the poles extend over the full extent(s) of the cup shaped magnets, the magnets 2 and 3 are maintained in the spaced apart orientation over their full extents. Therefore, since the shaft 1 is fixed to magnet 2, and extends through opening 5 in magnet 3 (which is fixed to support 8), the shaft 1 is effectively suspended from the support 8, and can rotate relative to support 8, without physical contact between shaft 1 and support 8.

As shown by the figures, there are preferably at least two pairs of cup shaped magnets that are spaced apart and suspend the first and second members. Each pair of magnets has an outer magnet 2 and an inner magnet 3, that are oriented in the manner shown in FIG. 2. In addition, when the shaft 1 is suspended from support 8 by the two pairs of the cup shaped magnets (2, 3), in the configuration illustrated in FIG. 2, the shaft 1 is also suspended and maintained in a predetermined self centered orientation relative to the support 8. The pairs of cup shaped magnets 2, 3, and their respective magnetic fields, effectively suspend the shaft 1 from the support 8 and also center the shaft 1 (longitudinally and vertically) relative to the support 8. Thus, the structure and orientation of the magnets 2, 3 and their magnetic fields, provides a magnetic frictionless coupling between the shaft 1 and the support 8, that produces a predetermined self centered orientation of the shaft 1 relative to the support 8, and maintains that self centered orientation of the shaft 1 relative to the support 8 as the shaft and the support rotate relative to each other.

As described above, in this application, reference to a magnet being “cup shaped” means that the magnet has a substantially continuous wall that defines an opening that encompasses a volume of the air that is about the magnet. Thus, as seen in FIGS. 1-5, each magnet preferably has a hemispherical configuration with one of the poles of the magnet on the concave inside of the magnet and the other pole of the magnet on the convex outside of the magnet. It does not matter whether the poles on the insides or outsides of the cup shaped magnets of each pair are north or south poles, so long as the orientation of the poles on each pair of magnets are oriented in the manner shown and described herein.

In the alternative, or modified embodiment of FIG. 3, the shaft 1 is connected to the support structure 8, and one or more coupling members 10 are connected to the outer magnets 2, so that the outer magnets 2 and coupling members form an member that is suspended from the shaft 1 without physical contact between that integral member and the shaft. In the embodiment of FIG. 3, the magnets 2, 3 are cup shaped, and spaced apart in the same manner as in FIGS. 1 and 2. Also, in the configuration shown in FIG. 3, the integral member is suspended from the shaft 1, and effectively centered on the shaft, without physical contact between the integral member and the shaft 1.

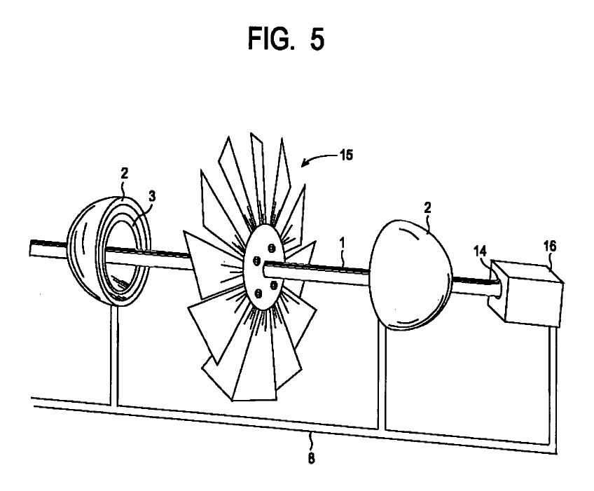

Also, with a frictionless coupling according to the principles of the present invention, a driver device can be connected with one of the inner or outer members. In FIG. 5, an example of a driver device is shown at 15 in the form of a series of windmill type blades connected to shaft 1. Alternatively, or in addition to the driver device, a device can be provided that produces energy from relative rotation between the members. In FIG. 5, that device is represented schematically as a transducer 16 that would convert rotation of shaft 1 into electrical energy in a manner well known to those in the art. Also, it should be noted that the housing of transducer 16 would include an opening 14 large enough to receive and allow rotation of shaft 1 without frictional contact with shaft 1.

A particularly useful structure that can be produced with the principles of the present invention is a hinge structure, in which the first and second members comprise hinge plates that can pivot relative to each other about a shaft 1. One hinge plate is connected to a frame and the other member is connected to a component (e.g. a door) that is supported for rotation relative to the frame by the hinge structure.

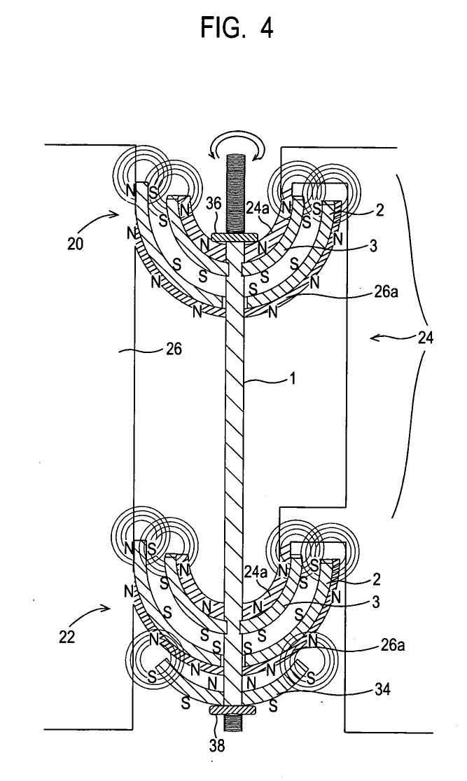

In the vertical hinge structure shown in FIG. 4, the first and second members comprise first and second hinge plates 24, 26 that are rotatable relative to each other about shaft 1. The inner magnets 3 of each pair of magnets are connected to hinge plate 24, by cup shaped coupling portions 24a, 24b that are shaped to fit inside the inner magnets 3 and can be adhesively secured to the inner magnets. The outer magnets 2 of each pair of magnets would be connected to the other hinge plate 26, by means of cup shaped coupling members 26a, 26b that extend from the hinge plate 26, and are shaped to receive the convex outsides of the outer magnets 2. The cup shaped members can be made of suitable metal or synthetic materials, and can be adhesively coupled to the convex outsides of the outer magnets 2. The cup shaped magnets of the pairs of magnets are configured to suspend one hinge plate from the other hinge plate in a predetermined self centered orientation and to allow relative pivotal movement of the hinge plates 24, 26 relative to each other about the shaft, without physical contact between the hinge plates.

With the hinge structure of FIG. 4, the pairs of magnets are spaced along the shaft 1 and allow relative pivotal movements of the hinge plates 24, 26 about the shaft. The inner magnets of each magnet pair is fixed to the shaft 1, in the manner described above in connection with FIG. 2. The cup shaped coupling portions 24a, 24b are received by the concave insides of the inner magnets, and the upper coupling portion 24a is pressed against the concave inside of upper inside magnet 3, by a nut 36 that is coupled to the shaft 1, so that the hinge plate 24, inner magnets 3, cup shaped coupling members 24a, 24b, and nut 36 all rotate together with shaft 1. The other hinge plate 26 is fixed to the outer magnets 2 by the cup shaped coupling structures 26a, 26b, and is centered and suspended from the hinge plate 24 by the magnetic fields of the cup shaped pairs of magnets.

In the arrangement shown in FIG. 4, the cup shaped magnets of each pair face in the same direction (i.e. in each pair of magnets the openings in the cup shaped magnets face upward). In that type of arrangement, additional structure is provided to maintain the frictionless suspension, in the form of a spacer magnet 34 that is fixed to the shaft 1 and spaced below the convex outside of the outer magnet 2 of the bottom magnet pair. The side of the spacer magnet 34 that faces the convex outside of the outer cup shaped magnet have similar poles, so that the magnet fields of the spacer magnet 34 and the outer cup shaped magnet maintain a frictionless relation between those members. A nut 38 presses against the spacer magnet 34 and helps couple the spacer magnet 34 with the shaft. Thus, the nut 38 and the spacer magnet 34 can rotate with the shaft 1 and the coupling plate 24, without any frictional contact between the nut and the outer magnet 2 of the lower magnet pair. This feature is useful when the pairs of cup shaped magnets face in the same direction, but is not necessary when the pairs of cup shaped magnets face in opposite directions (i.e. they face each other as in FIGS. 1, 2, 3 and 5).

Thus, as seen from the foregoing description, the present invention provides a frictionless suspension structure that can suspend one member from the other without physical contact between the members. It is also recognized that in certain applications of the present invention, it may be further desirable to reduce or eliminate the effect of air friction on the suspension system. To do that, it is contemplated that one or more flywheels may be added to the moveable member (e.g. the shaft in FIG. 1), to add inertia to the shaft and thereby allowing the shaft to rotate longer, despite any effects due to air friction. In addition, in an application designed to collect energy from a rotating member, it may be desirable to add the flywheels and also place the whole structure in a vacuum, to reduce, or even eliminate, the effect of air friction.

Also, while the exemplary embodiments shown and described above provide two pairs of inner and outer magnets that are spaced apart along the members, it is contemplated that additional pairs of inner and outer magnets can be provided to provide additional frictionless suspension structure for the members.

The present invention provides a simple method for achieving a frictionless axle, hinge and or bearing. The root invention is based on this simple concept. Four magnetic rings (permanent or electromagnetic) (roughly concave and/or convex in shape) two of them magnetized north pole on the concave side and two magnetized north pole on the convex side. In assembling a frictionless support structure, e.g. of the type shown in FIGS. 1 and 2, first use two of these magnetic rings as. bearings and attaching them to an mount (concave (North) facing outward). Second, extend a shaft (preferably of non-ferric material) through the bearing rings. Third, attach the other two magnetic rings to the shaft (convex (North) facing inward) one at each end. Fourth, pull the two shaft magnets toward the bearing magnets until the magnetic repulsion between the bearing magnets and the shaft magnets (now called a levitating pair) levitates the shaft to a stable and centered position. Thus creating a free floating and self-supporting shaft able to spin within frictionless magnetic bearings. The levitating pairs can be configured in many different ways according to the applications requirement. For instance, all levitating pairs facing upward to support upright hinge type applications. As many levitating pairs as necessary and facing whatever directions needed for the application. Either the shaft or the bearings or any combination can be immobile according to the need of the application.

The applications for this concept are almost endless. Anything large or small that uses hinges, axles and bearings. Some examples are described below.

1. Hinges of all shapes and sizes. The hinges can be configured in different ways. For instance for larger doors the two, three or more levitating pairs could be placed concave facing up to support the extra weight with solid attachment connected to the axle instead of the bearing or a combination of both.

2. Small household appliances that use hinges, axles or bearings.

a. Cabinets with roll out or swing out surfaces.

b. Cabinet and table top lazy susans.

c. Table and chair rollers.

3. Larger axle applications.

a. Windmill electric generator. Could attach windmill fan blades to both ends of the axle.

b. Railroad car axles. A huge energy saver. (If magnets can be made large enough and strong enough for the task)

c. Perpetual motion machine with power generation. (if PM is possible a simple frictionless axle will be central to the design)

4. Electric motors. (More efficient with a frictionless shaft)

The applications are only limited by the imagination.

(There may be two other ways to center the shaft. 1. adding magnets to the shaft at the point apposing the inside of the bearing magnet to help center the shaft. 2. If flat magnets are used instead of concave magnets you may be able to center the shaft using magnets surrounding the shaft magnets to keep them centered. This configuration may also be assisted by additional shaft magnets apposing the inside of the bearing magnets.)

Thus, the foregoing description shows how the principles of the present invention can be used to provide various frictionless suspension structures. With those principles in mind, the manner in which the principles of the present invention can be used in various frictionless suspension structures will be apparent to those in the art.

What is claimed:

1. Frictionless suspension structure comprising a first member with at least one magnet connected thereto and a second member with at least one magnet connected thereto, the magnets connected with the first and second members configured and oriented with respect to each other to (i) establish respective magnetic fields that interact to suspend one of the members from the other member in a predetermined self centered orientation without physical contact between the members, and (ii) maintain the one of the members suspended from the other member in the predetermined self centered orientation without physical contact between the members.

2. Frictionless suspension structure as defined in claim 1, wherein the first and second members have respective pairs of magnets that interact to suspend and maintain the one member suspended from the other member in the predetermined self centered orientation without physical contact between the members.

3. Frictionless suspension structure as defined in claim 2, wherein each respective pair of magnets comprises an inner magnet and an outer magnet, and the interaction between the magnetic fields of the inner and outer magnets is configured to enable the members to rotate relative to each other while being maintained in the predetermined self centered orientation without physical contact between the members.

4. Frictionless suspension structure as defined in claim 3, wherein the magnets of each respective pair of magnets each have a cup shaped configuration and each cup shaped magnet on the inner member is configured to be located inside and suspended from a respective cup shaped magnet on the outer member, without physical contact between the cup shaped magnets.

5. Frictionless suspension structure as defined in claim 4, wherein each of the cup shaped outer magnets has a pole on the concave inside of the cup shaped magnet, and each of the cup shaped inner magnets has a similar pole on the convex outside of the cup shaped magnet.

6. Frictionless suspension structure as defined in claim 5, wherein one of the first and second members comprises a support structure and the other member is suspended from the support structure by the interaction of the magnetic fields of the pairs of magnets, the cup shaped magnets and their respective magnetic fields configured to maintain the other member suspended from the support structure in the predetermined self centered orientation.

7. Frictionless suspension structure as defined in claim 6, wherein the inner magnets of each of the pairs of magnets are coupled to the other member and the outer magnets of each of the pairs of magnets are coupled to the support structure.

8. Frictionless suspension structure as defined in claim 6, wherein the outer magnets of each of the pairs of magnets are coupled to each other by coupling structure to form the other member and the inner magnets of each of the pairs of magnets are coupled to the support structure.

9. Frictionless suspension structure as defined in claim 3, further including a driver device connected with one of the inner or outer members.

10. Frictionless suspension structure as defined in claim 3, further including a device that produces energy from relative rotation between the inner and outer members.

11. Frictionless suspension structure as defined in claim 6, wherein the first and second members comprise first and second hinge plates, the hinge plates being relatively rotatable about a shaft, the inner magnets of each pair of magnets connected to one hinge plate and the outer magnets of each pair of magnets connected to the other hinge plate, in a manner that suspends one hinge plate from the other hinge plate in a predetermined self centered orientation and allows relative pivotal movement of the hinge plates relative to each other about the shaft, without physical contact between the hinge plates.

12. Frictionless suspension structure as defined in claim 11, wherein the pairs of magnets are spaced along the shaft and allow relative pivotal movements of the hinge plates about the shaft.

13. Frictionless suspension structure as defined in claim 12, wherein one of the hinge plates has a pair of concave portions that are received by and pressed against the concave inner surfaces of the inner magnets of each of the magnet pairs, and the other hinge plate has concave portions that receive and are pressed against the convex outer surfaces of the outer magnets of the of the magnet pairs.

14. Frictionless suspension structure as defined in claim 13, wherein each of the magnet pairs has concave portions that face in the same direction, and wherein a spacer magnet is connected with the one hinge plate that is pressed against the inner magnets, and is spaced from the outer convex surface of one of the pairs of magnets that are connected to the other hinge plate, the spacer magnet and the outer convex surface of the magnet connected to the other hinge plate have magnetic fields that maintains the spacer plate in spaced from the outer convex surface of the one of the pairs of magnets connected to the other hinge plate, without physical contact between the outer convex surface and the spacer magnet.
